(19) United States
(12) Patent Application Publication
(10) Pub. No.: US 2015/0310334 A1
(43) Pub. Date: Oct. 29, 2015

(54) METHOD AND APPARATUS FOR ASSESSING USER EXPERIENCE

(71) Applicant: TELEFONAKTIEBOLAGET L M ERICSSON (PUBL), Stockholm (SE)

(72) Inventor: Vincent HUANG, SOLLENTUNA (SE)

(73) Assignee: TELEFONAKTIEBOLAGET L M ERICSSON (PUBL), Stockholm (SE)

(21) Appl. No.: 14/651,117

(22) PCT Filed: Dec. 13, 2012
(86) PCT No.: PCT/EP2012/075371

§ 371 Date: Jun. 10, 2015

(51) Int. Cl. G06N 5/04; G06N 99/00

(52) U.S. Cl. CPC G06N 5/04; G06N 99/005

(57) ABSTRACT

A method of assessing user experience is disclosed. The method comprises the steps of monitoring network data and user-user equipment interaction data for a plurality of users within the network (step 110), generating a measure of user experience from the monitored user-user equipment interaction data for at least some of the plurality of users (step 120) and inferring a function relating network data to user experience measure from the monitored network data and the generated user experience measures (130). The method further comprises using the inferred function to predict user experience measures from network data for users within the network (step 140). Also disclosed are a computer program product for carrying out a method of assessing user experience and a system (200) configured to assess user experience.

### TECHNICAL FIELD

The present invention relates to a method and an apparatus for assessing user experience. The invention also relates to a computer program product configured to carry out a method for assessing user experience.

### BACKGROUND

User Experience (UX) indicates how the process of accessing or interacting with a product, system or service is experienced by a user. User experience can be an important factor in product and service design, as well as in business management and development across a range of industrial and service sectors.

In the telecommunications industry, network operators and other service providers supply a range of services to users via distributed telecommunications networks. User experience is a highly important indicator for operators and providers seeking to offer improved service to users and hence to maintain and enlarge their customer base. Churn rate is a measure of the proportion of contractual customers or subscribers who leave an operator or supplier during a given time period. Reducing churn rate is an important business aim for network operators and service providers, and user experience is a key indicator in seeking ways to achieve this.

When considering the provision of services over a telecommunications network, the concept of user experience encompasses both practical aspects of service functionality; how well a service is functioning, as well as more subjective aspects of a user's perception of their service experience. User experience may be affected by user state and previous experiences of a particular service, as well as by service and/or network properties and by functionality of any equipment used to access the service. Usage context can also affect service experience, different aspects of service performance taking on greater or lesser importance depending upon the particular context in which the service is accessed. User experience evolves over time with changing circumstances.

Numerous attempts have been made to generate measurement methods for assessing user experience of users accessing services. These methods typically measure data relevant to user experience and apply numerical algorithms to the data to extract a meaningful measure of the user experience. One example of these methods is eye tracking. Eye tracking technology has been developed for multiple applications and can be used for example to warn of driver fatigue by analysing eye focus. Applied to the display of media content on a screen, eye tracking can be used to measure what areas of a screen the user is looking at and for how long a user's gaze is focussed on a particular part of the screen. This data can be used to analyse what content a user is interested in, whether attention is wandering or focussed and other aspects of how the user is experiencing the displayed content. Other types of sensors can be combined with eye tracking to measure different aspects of user interaction with the display screen or apparatus, as well as user inputs to the apparatus, to build a picture of user experience. Increasing usage of sensors allows for generation of more accurate and complete analysis methods for user experience evaluation.

With the rapid development of mobile technology, sensors and sensing capabilities are being incorporated into smart phones and other mobile computing devices. Accelerometers may be incorporated into a mobile device to allow identification of user gestures, activity and movement patterns. This information may be combined with eye tracking data to provide increasingly accurate indications of user experience. However, the availability of this user experience data remains limited. While development of sensing capabilities in mobile devices continues to progress, the vast majority of mobile devices do not yet have such capability and so user interaction with these devices cannot be measured and used to indicate user experience. In addition, central analysis of sensor data recorded at a mobile device requires that this data be communicated to a central or core region of the network. Continuous analysis of changing user experience would therefore require continual transmission of sensor data, adding to network traffic and placing further demands on often limited network bandwidth. Communication interfaces between mobile devices and a core network may also be unsuited for transmission of sensor data to the core network.

### SUMMARY

It is an aim of the present invention to provide a method, apparatus and computer program product which obviate or reduce at least one or more of the disadvantages mentioned above.

According to a first aspect of the present invention, there is provided a method of assessing user experience for users accessing a network via user equipment, the method comprising monitoring network data and user-user equipment interaction data for a plurality of users within the network and generating a measure of user experience from the monitored user-user equipment interaction data for at least some of the plurality of users. The method further comprises inferring a function relating network data to user experience measure from the monitored network data and the generated user experience measures and using the inferred function to predict user experience measures from network data for users within the network.

The plurality of users for whom network data and user-user equipment interaction data are monitored may comprise s first group of users within the network. The first group of users may be a subset of users within the network. The inferred function may be used to predict user experience measures from network data for a second group of users within the network. The second group of users may comprise at least some of the network users not comprised in the first group. The second group may comprise at least some of the users within the network for whom user-user equipment data has not been monitored.

Aspects of the present invention thus enable assessment of user experience based solely on network data, which data is easily available from network processors. This allows for assessment of user experience much more easily than has previously been the possible, and for all users within a network, as opposed to only those users for whom sensed interaction data is available from their mobile device. In contrast to the prior art methods of measuring User experience through sensed data which is only available for a small proportion of users. Aspects of the present invention predict a measure of user experience based on much more widely available network data and an inferred prediction function.

For the purposes of the present specification, a user experience measure is a quantitative representation of user experience for a particular user. As discussed above, the concept of user experience encompasses a wide range of different aspects of service performance and user perception. A user experience measure is a quantitative representation of this concept for a user.

Network data may include any aspect of information about the network as it relates to a particular user. This may include for example user equipment, operating system, network traffic data etc. User equipment includes mobile devices such as mobile phones, smart phones, tablets, laptops etc.

For the purposes of the present specification, “user-user equipment interaction” encompasses all aspects of the interaction between a user and their user equipment which may be captured by sensor or otherwise and which may allow generation of a UX measure.

In some examples, network data and user-user equipment interaction data may be monitored for the plurality of users during a particular time span, and/or with relation to a particular service. In some examples, the steps of monitoring data, generating user experience measures and inferring a function may be repeated periodically, thus allowing for updating of the inferred function.

In some examples, monitoring user-user equipment interaction data may comprise receiving and storing user-user equipment interaction data measured by sensors. Sensors may be integral to the user equipment or may be peripheral, for example communicating with the user equipment via a physical connection such as an auxiliary port or via a remote connection such as Bluetooth. Examples of sensors may include cameras for eye tracking, accelerometers etc.

In some examples, generating a measure of user experience may comprise applying an algorithm to the user-user equipment interaction data to arrive at a user experience measure. Many examples exist of suitable algorithms for generating a measure of user experience form sensed user-user equipment interaction data such as eye tracking data and accelerometer data. The generated measure of user experience may for example be a numerical measure such as a scalar, vector, matrix or multidimensional array. A numerical measure of this type may lend itself to further manipulation and may be generated using established algorithms linking sensed data to user experience.

In some examples, inferring a function may comprise applying a machine learning technique to produce an inferred function. In some examples, the machine learning technique may be a supervised learning technique which may employ the monitored network data and generated user experience measures as training data.

Examples of machine learning techniques may include regression models and neural networks. Other supervised learning techniques may be employed and any suitable loss function may be selected according to the machine learning technique.

In some examples, the method may further grouping users within the network according to at least one user attribute and selecting the plurality of users form a single group within the network. In this manner, the method may infer a function that is targeted towards a particular group of users. By grouping users according to particular user attributes, and inferring a function using data form users within a single group, a targeted prediction function appropriate to that group can be developed. Aspects of the present invention thus allow for the development of a series of accurate prediction models targeted to specific groups of users. Groups of users may for example include business users, occasional users, high consumption users etc. In some examples, grouping may be carried out using a clustering algorithm and may be performed for example on the basis of attributes recorded in customer relationship management (CRM) data.

According to another aspect of the present invention, there is provided a computer program product configured, when run on a computer, to implement a method according to the first aspect of the present invention. The computer program product may be stored on a computer-readable medium, or it could, for example, be in the form of a signal such as a downloadable data signal, or it could be in any other form. In some examples, the computer program product may be incorporated in core network processors. In other examples, the computer program product may comprise several sub programs, some of which may be incorporated within a core network processor and others of which may be incorporated within user equipment. Some or all of the computer program product may be made available via download from the internet.

According to another aspect of the present invention, there is provided a system configured to assess user experience for users accessing a network via user equipment. The system comprises a monitoring unit configured to monitor network data and user-user equipment interaction data for a plurality of users within the network, a generating unit configured to generate a measure of user experience from the monitored user-user equipment interaction data for at least some of the plurality of users a learning unit configured to infer a function relating network data to user experience measure from the monitored network data and the generated user experience measures, and a prediction unit configured to use the inferred function to predict user experience measures from network data for users within the network.

In some examples, the system may be realised within a core network or within another part of a radio system supporting a network. In other examples, units of the system may be realised within user equipment devices. For example, monitoring of interaction data and generation of user experience measures may be conducted at user equipment devices. User experience measures generated at a user equipment may be transmitted from the user equipment to a core network to allow learning and prediction to take place at the core network. According to aspects of the present invention, the system may thus be distributed between a core network and many different user equipment devices.

In some examples, the system may be at least partially realised within a network apparatus such as a network processor or processors. The monitoring unit of the system may be configured to receive data for monitoring from different sources, including user equipment and network processors.

In some examples, the monitoring unit may comprise a network monitoring unit configured to receive and record network data and an interaction monitoring unit configured to receive and record user-user equipment interaction data. As discussed above, network data may include any or all network information as it relates to a particular user and may for example include user equipment, operating system and network traffic data. User-user equipment interaction data may for example be captured by sensors mounted on or in communication with the user equipment.

In some examples, the interaction monitoring unit may comprise a plurality of interaction monitoring components, and each interaction monitoring component may be realised within a specific user equipment.

In some examples, the generating unit may comprise a plurality of generating components, and each generating component may be realised within a specific user equipment.

According to some examples of the invention, the system may therefore be distributed between for example a core network and many user equipment devices. The interaction monitoring unit and the generating unit may thus be constituted by a plurality of individual monitoring and generating components, each monitoring interaction data and generating user experience measures for a specific user and user equipment. The generated user experience measures may then be communicated to the learning unit for subsequent processing.

In some examples, the learning unit may be configured to apply a machine learning technique to produce an inferred function. The machine learning technique may be a supervised learning technique and the learning unit may be configured to employ the monitored network data and generated user experience measures as training data for the supervised learning technique.

According to another aspect of the present invention, there is provided a network apparatus comprising a network monitoring unit configured to monitor network data, a learning unit and a predicting unit configured to predict user experience measures for users within the network. According to the present aspect, the learning unit may be configured to receive network data form the network monitoring unit, receive a user experience measure from a user apparatus and infer a function relating network data to user experience measure. The predicting unit may be configured to use the inferred function to predict user experience measures.

According to another aspect of the present invention, there is provided a user apparatus comprising an interaction monitoring component configured to monitor interaction data between a user and a user equipment associated with the user apparatus, and a generating component configured to generate a measure of user experience form the monitored user-user equipment interaction data. According to the present aspect, the generating component may further comprise a transmitting component configured to transmit the user experience measure to a network apparatus.

The user apparatus may for example be formed integrally with a user equipment such as a handset, smart phone, tablet etc.

### BRIEF DESCRIPTION OF THE DRAWINGS

For a better understanding of the present invention, and to show more clearly how it may be carried into effect, reference will now be made, by way of example, to the following drawings in which:

FIG. 1 is a flow chart illustrating steps in a method of assessing user experience for users accessing a network.

FIG. 2 is a block diagram illustrating functional elements of a system for assessing user experience of users accessing a network.

FIG. 3 is an operational diagram illustrating functioning of a method and system for assessing user experience for users accessing a network.

FIGS. 4 and 5 are flow charts illustrating steps in another embodiment of method of assessing user experience for users accessing a network.

FIGS. 6 and 7 are flow charts illustrating some of the steps in another embodiment of method of assessing user experience for users accessing a network. FIG. 6 illustrates steps conducted at a user equipment and FIG. 7 illustrates steps conducted at a network apparatus.

FIG. 8 is a block diagram illustrating functional units of a network apparatus and examples of user apparatus.

### DETAILED DESCRIPTION

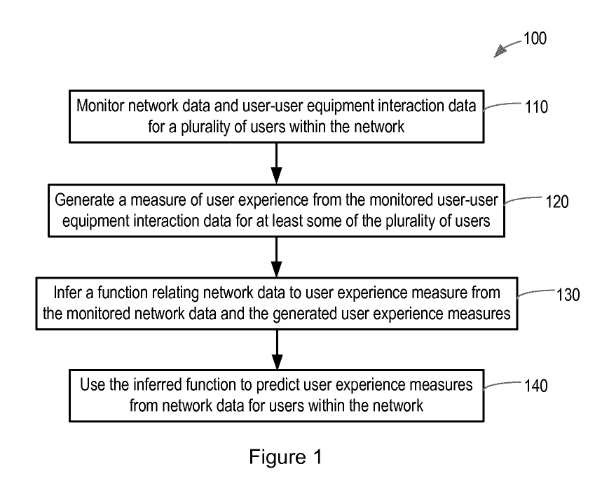

FIG. 1 illustrates steps in a method 100 of assessing user experience for users accessing a network via user equipment. The network may for example be a telecommunications network via which users may access services offered by the network operator or other service providers.

With reference to FIG. 1, a first step 110 of the method comprises monitoring network data and user-user equipment interaction data for a plurality of users within the network. The method then proceeds at step 120 to generate a measure of user experience from the monitored user-user equipment interaction data for at least some of the plurality of users. Once the user experience measures have been generates, the method proceeds, at step 130 to infer a function relating network data to user experience measure from the monitored network data and the generated user experience measures. Finally, at step 140, the method uses the inferred function to predict user experience measures from network data for users within the network.

As noted above, existing methods of assessing user experience for users accessing a network involve applying algorithms to user interaction data sensed at the user equipment used to access the network. These methods suffer from disadvantages relating to increased network traffic and a lack of available sensed information, owing to the relatively few user equipment devices currently equipped with suitable sensing capabilities. According to the present invention, rather than seeking to measure user experience, a prediction model may be generated, allowing a representative measure of user experience to be predicted based upon network data. Network data for all users, regardless of their particular user equipment, is easily available to network processors and does not require any additional network traffic.

Network data for a user may include details of user equipment and user equipment operating system as well as network traffic data relating to the user. Network traffic data may for example include parameters from Deep Packet Inspection (DPI) such as service type, transportation protocol, application, platform etc. Network traffic data may also include information such as packet delay, inter arrival time, packet loss rate etc. Other examples of network data can be envisaged. Network data may be assembled as a scalar or as a vector, matrix or multidimensional array, in which each numerical entry may represent a different facet of network data.

User-user equipment interaction data may include all information on how a user is interacting with their user equipment. This may for example include eye focus, gestures, movement patterns etc. In one example, user-user equipment interaction data is sensed by sensors which may be integral with a user equipment device or may communicate with the user equipment device for example via Bluetooth or other wired or wireless communication means. According to one example, the sensors include at least one of eye tracking sensors and an accelerometer, although these are merely examples of sensors which may be used to gather user-user equipment interaction data.

The step 110 of monitoring network data and user-user equipment interaction data may comprise receiving and storing network data from for example a network server, and receiving and storing user-user equipment interaction data from a user equipment device. Modifications may need to be made to a standard interface between user equipment and core network apparatus to allow for the communication of interaction data from user equipment devices equipped with sensors to network processors within which inferring of a prediction function may take place.

The plurality of users for which interaction data and network data are monitored may be selected from a specific group, as discussed in further detail below. Selection may be performed using sampling techniques such as diverse random sampling for example. The number of users for which interaction and network data are monitored may be selected according to the training data requirements of the learning function used to infer the prediction function at step 130.

Monitoring of user-user equipment interaction data for the plurality of users enables the generation, at step 120 of measures of user experience for at least some of the plurality of users. According to one example, a measure of user experience may be generated for all of users for which user-user equipment interaction data has been monitored. In other examples, monitoring may take place for a great number of users, with user experience measures being generated for only a subset of those users for which user-user equipment interaction data is available. User equipment measures may be generated by the application of any suitable algorithm to the monitored interaction data. As discussed above, many algorithms have been developed to generate measures of user experience from raw sensed data indicating eye tracking, movement patterns etc. In one example the generated user experience measures may comprise matrices, with each numerical element conveying an indication of a different aspect of user experience. In other examples the user experience measures may be vectors or scalar values.

Once user experience measures have been generated, the method can proceed at step 130 to infer a function relating network data and user experience measures. According to one embodiment, this may be achieved by assembling network data and generated user experience measures as training data for a supervised machine learning algorithm. In supervised machine learning techniques, a subset of data, known as training data, is used to enable a machine to infer a function or classifier for analysing the data. The training data consists of a series of input objects each of which is labelled with an associated output. By analysing the training data the machine infers a function allowing it to correctly predict an output value for any valid input object. According to examples of the present invention, network data for a user may be employed as an input, with the generated user experience measure for the user as the associated output. A training pair of network data and user experience measure may thus be assembled for each of the users for which appropriate data has been monitored and the necessary measure has been generated.

A machine learning algorithm may analyse the training data pairs and generate a function able to predict a user experience measure for any valid input of network data. Any suitable supervised learning algorithm may be used, including for example a neural network or regression method. A loss function may be employed to arrive at a prediction function which minimises the number of incorrect predictions and/or magnitude of errors based upon the training data. A suitable loss function may be chosen according to the machine learning function employed.

Once a suitable prediction function has been inferred from the training data, the prediction function may be used, at step 140 to predict user experience measures from network data for users within the network. At this stage, user-user equipment data is no longer required, and additional communication between the user equipment and the network is not necessary. Network processors can access network data for any user within the network and use the inferred prediction function to predict a user experience measure for the user. This prediction can be made in real time, allowing real time assessment of user experience levels across the network and hence affording the possibility of action by a network operator to adjust network resource allocations, service offerings or other parameters according to current user experience measures for users within the network. Predicted user experience data may have many other beneficial uses in network management and in customer care. Lower user experience measures across many users in a particular geographical area or at particular times may indicate a need to adjust network resource or resource management practices in those areas or at those times. Users experiencing prolonged lower user experience measures may be targeted for special treatment or compensatory measures. Also, users experiencing prolonged high user experience measures may be targeted for advertising campaigns or inducements to subscribe to additional services. The users for whom user experience measures are predicted may be users within the network for whom user-user interaction data was not monitored in step 110. In other examples, user experience measures may be predicted for any user within the network, enabling assessment of user experience without the need for transmitting user-user experience data.

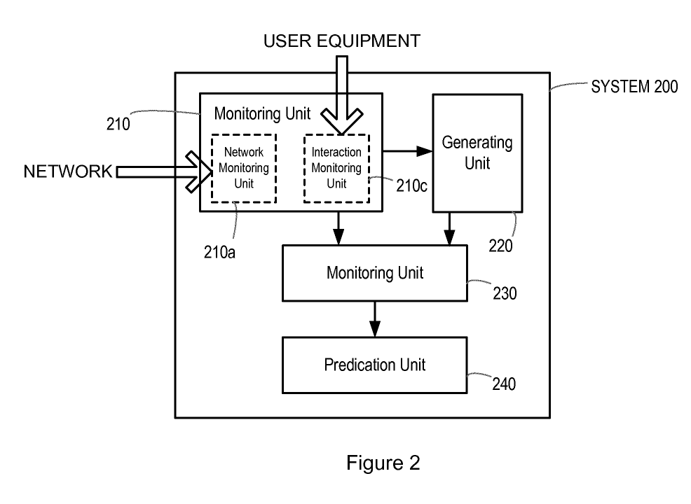

The method 100 of FIG. 1 may be realised by a computer program which may cause a system, processor or apparatus to execute the steps of the method 100. FIG. 2 illustrates functional units of a system 200 which may execute the steps of the method 100, for example according to computer readable instructions received from a computer program. The system 200 may for example be realised in one or more processors, system nodes or any other suitable apparatus.

With reference to FIG. 2, the system 200 comprises a monitoring unit 210, a generating unit 220, a learning unit 230 and a prediction unit 240. It will be understood that the units of the system are functional units, and may be realised in any appropriate combination of hardware and/or software.

According to an example of the invention, the monitoring unit 210, generating unit 220, learning unit 230 and prediction unit 240 may be configured to carry out the steps of the method 100 substantially as described above. The monitoring unit may be configured to monitor network data and user-user equipment interaction data for a plurality of users within the network. The monitoring unit may comprise a network monitoring unit 210a and an interaction monitoring unit 210c. The network monitoring unit 210a may be configured to receive and store data from the network, for example form network processors. The interaction monitoring unit 210c may be configured to receive and store interaction data from user equipment devices. The generating unit 220 may be configured to receive the monitored interaction data for the monitoring unit 210 and to generate user experience measures for the users for which interaction data has been monitored. The learning unit may be configured to receive network data from the monitoring unit and user experience measures from the generating unit, and to infer a prediction function linking network data to user experience measure. Finally, the prediction unit 240 may be configured to use the inferred prediction function to predict user experience measures fro users within the network based upon network data alone.

It may be appreciated from the above discussion of FIGS. 1 and 2 that operation of the present invention may be divided into two phases: a training phase and a prediction phase. During the training phase the method/system obtains network data and associated user experience measures for a certain number of users. This data is obtained through monitoring and appropriate generation of user experience measures. The method/system then uses the obtained data as training data to infer a function able to predict user experience measures from input network data. The training phase is reflected in steps 110, 120 and 130 of FIG. 1, conducted by units 210, 220 and 230 of the system of FIG. 2. During the prediction phase, the inferred function is used to predict user experience measures for users within the network. These user experience measures are predicted solely on the basis of network data for the users, without requiring user-user equipment interaction data.

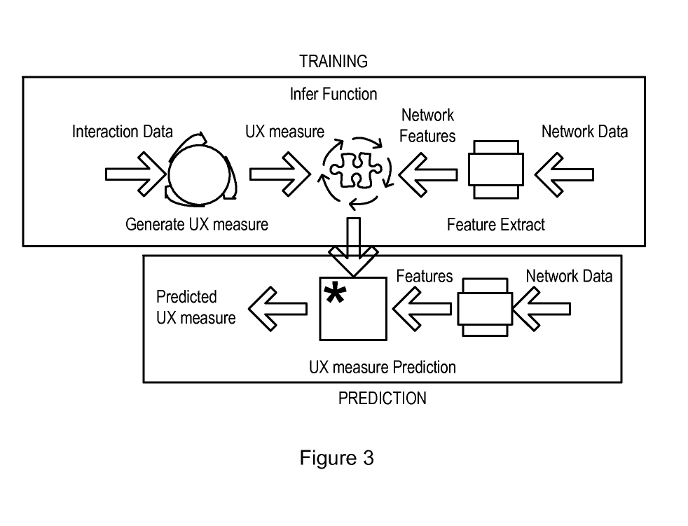

The two phases of operation of the present invention are illustrated in FIG. 3. The training phase, at the top of the Figure, can be seen to comprise inputs of interaction data and network data. From the interaction data user experience measures are generated to be supplied to the learning unit 230. From the network data, the required network features may be extracted to provide network data in a form suitable for processing by the learning unit 230. This extraction of features may for example be necessary to convert monitored network data into a suitable mathematical form for manipulation by the learning unit. As discussed above, the learning unit 230 uses training data to infer a prediction function, allowing prediction of an output (user experience measure for any valid input (network data). In order to generate the prediction function, the learning unit may require both network data and user experience measures to be presented in a suitable format, for example as matrices. The learning unit 230 generates the required prediction function which is then employed during the prediction phase of the invention, illustrated at the bottom of the Figure. The prediction phase can be seen to comprise an input of network data, from which relevant network features may be extracted, for example in a required vector, matrix or array form as discussed above. The network features are presented to the inferred prediction function as an input and a predicted user experience measure is generated by the prediction function as an output.

It has already been discussed that some modification of an interface between user equipment and network processors may be required in order to allow user equipment devices to communicate user-user equipment interaction data to the network. It will be appreciated that this modified interface is only required during the training phase of the invention. Similarly, increased traffic between user equipment and network processors is only present during the training phase. Once the prediction phase has been entered, all information required to predict user experience measures is available within the network, no additional information is required from the user equipment.

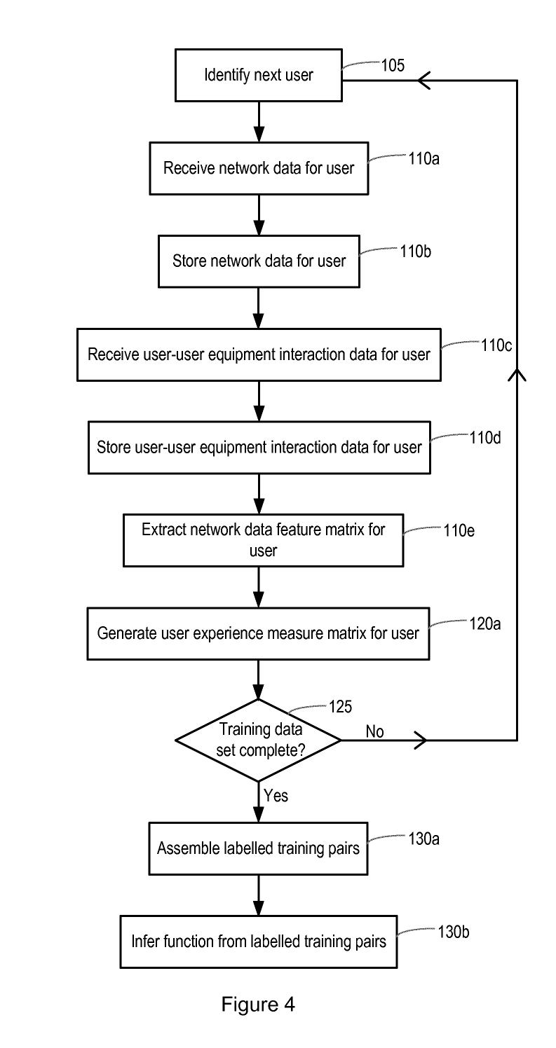

FIG. 4 illustrates in more detail the training phase of the present invention from the point of view of a core network or other network location at which the method of the present invention may be implemented. FIG. 4 illustrates how the steps of the method 100 may be further subdivided in order to realise the functionality described above. The method 100 may also comprise additional steps such as user clustering described in more detail below.

As discussed above, it may be desirable to select users for provision of training data from a particular group within the network. A single telecommunications network may include users having widely differing requirements and expectations of the network, and accessing different services. It will be appreciated that an occasional user of services for private use may have a very different usage profile and expectation to say a business user who relies upon network service to conduct their business. The accuracy of an inferred prediction function is dependent upon the accuracy of the training data used to develop it. The accuracy of the training data can be improved by selecting similar users to provide the training data. Thus a series of prediction models may be generated for different groups of users within the network. One example of how this may be achieved is to cluster users in the network according to different user attributes. These attributes may be selected according to operator requirements but may for example include type of contract (personal/business), service usage, average monthly spend etc. Clustering may be performed using any one of a number of suitable clustering algorithms. Once the users have been clustered, a single cluster may be selected for analysis, and users within that cluster may be monitored to provide training data. The step of clustering users according to user attributes may be conducted before the first step of the training phase as illustrated in FIG. 4.

Referring to FIG. 4, a first step 105 in the training phase comprises identifying a next user. This may be a next user simply within the network or within a particular user cluster targeted for generation of a prediction model. Once the next user has been identified, the method proceeds, at step 110a to receive network data for the user. This network data is then stored in a memory at step 110b. At step 110c, the method receives user-user equipment interaction data for the user, which data is stored in a memory at step 110d. At step 110e, network data features are extracted from the stored network data for the user. This may comprise, as illustrated in FIG. 4, the extraction of a network feature matrix or network features in any form suitable for subsequent use as training data, for example in the form of a vector or multidimensional array.

In step 120a, a user experience measure is generated for the user. This is illustrated in FIG. 4 as a user experience measure matrix, in a form suitable for use as training data. However it will be appreciated that other forms for the user experience measure may be contemplated according to the learning algorithm to be employed. For example a user experience measure vector, scalar or multidimensional array may be generated at step 120a. Having assembled the user experience measure matrix and network data matrix for the user, the method checks whether the training data set is complete at step 125. This may comprise checking whether or not enough user data has been assembled to allow generation of a suitable prediction model. The amount of training data required may be determined by a network operator or may be indicated by the learning algorithm to be employed. In some instances, the amount of training data available may be limited by the number of users having user equipment devices able to supply the necessary user-user equipment interaction data.

If at step 125 it is determined that the training data set is not complete, the method returns to step 105 to identify the next user and assemble the necessary data.

Once the training data set is determined to be complete at step 125, the method proceeds at step 130a to assemble the labelled training pairs. This step may comprise placing the user experience measures and associated network data for the various users into a suitable form for subsequent processing by the learning algorithm to be employed.

In a final training phase step 130b, a function for predicting user experience measures from network data is inferred from the labelled training pairs. This step may, as discussed above, comprise applying a supervised machine learning algorithm to the training pairs to arrive at a suitable prediction function.

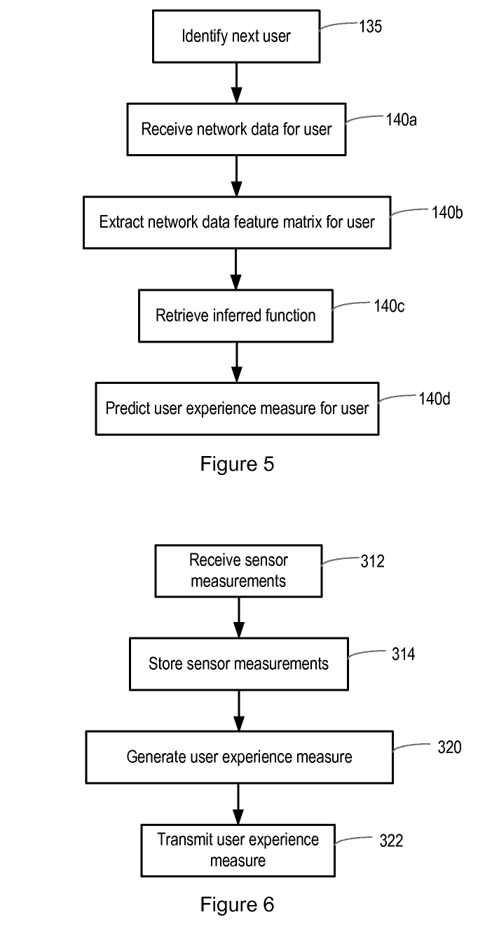

FIG. 5 illustrates in more detail the prediction phase of the present invention from the point of view of a core network or other network location at which the method of the present invention may be implemented. FIG. 5 illustrates how the step 140 of the method 100 may be further subdivided in order to realise the functionality described above.

In a first prediction step 135, the method illustrated in FIG. 5 identifies a next user for prediction of user experience measure. This may be any user from the network, a specific user, a user from a specific group etc. The next user may be identified according to particular user attributes, depending upon the requirements of a network operator or service provider. In a next step 140a, the method receives network data for the identified user. The method then extracts from the received network data a network data feature matrix (or vector, scalar or array) for use as an input to the prediction function. The method then proceeds to retrieve the inferred prediction function. In some examples, these may be only a single prediction function for use with all users in the network. In other examples, as discussed above, a series of prediction functions targeted to specific user groups or types of users may be generated. In this example, retrieving the inferred prediction function at step 140c may comprise identifying whether or not the user belongs to a particular user group and if so to which group. The step may then further comprise retrieving the appropriate prediction function for the group to which the identified user belongs.

Having retrieved the inferred prediction function, the method proceeds, at step 140d, to predict a user experience measure for the user. The predicted user experience measure may then be used in any way required by the network operator or service provider implementing the method of the present invention.

It will be appreciated that certain of the steps of the method 100 described above with reference to FIGS. 4 and 5 may be conducted in a different order from that which has been described and illustrated. For example, user-user equipment interaction data may be received and processed before network data. The ordered steps illustrated in FIGS. 4 and 5 are merely an example of one way in which the functionality of the method of the present invention illustrated in FIG. 1 may be realised.

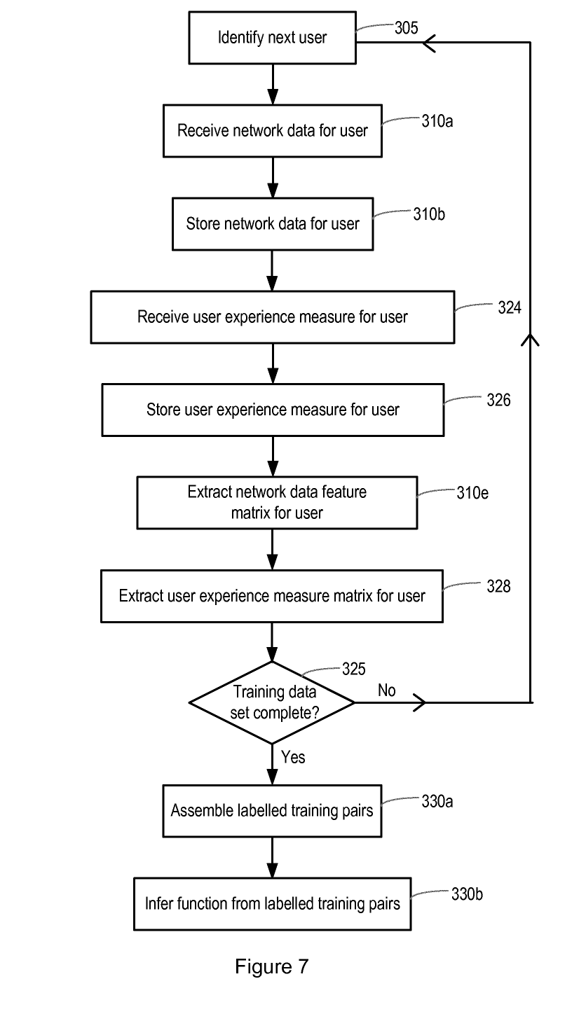

FIGS. 4 and 5 illustrate an example in which as much as possible of the training phase is conducted at the network, in the core network or another network location. However, in some examples, it may be desirable or appropriate to spread more of the training phase functionality to the user equipment. FIGS. 6 and 7 illustrate another example of how the training phase steps may be distributed between user equipment and network apparatus, with more functionality being carried out at the user equipment. FIG. 6 illustrates training phase steps conducted at the user equipment, for example by a user apparatus mounted on or in a user equipment device. FIG. 7 illustrates training phase steps conducted at the network, for example by a network node or processor.

Referring to FIG. 6, in a first step 312 conducted at the user equipment, sensor measurements are received from sensors mounted on or in communication with a user equipment device. These sensor measurements are then stored in a step 314 and a user experience measure is generated from the stored sensor measurements at step 320. The user experience measure may be generated using a suitable algorithm as discussed above. Once the user experience measure has been generated at step 320, the user experience measure is transmitted to the network at step 322. The transmitted user experience measure is received at the network in a step 324 illustrated in FIG. 7.

Referring to FIG. 7, in a first step 305, conducted at the network, a next user is identified. This is followed by receiving network data for the identified user at step 310a and storing network data for the user at step 310c. These steps may be performed substantially as described above with reference to FIG. 4. At step 324 the method received a user experience measure for the identified user from the user equipment device. The method then proceeds at step 326 to store the user experience measure for the identified user. At step 310e the method extracts a network data feature matrix for the identified user, and at step 328 the method extracts a user experience measure matrix for the identified user. This may be appropriate in the event that the user experience measure generated at the user equipment and transmitted to the network is not in a form suitable for use as training data in the learning unit. Once the network data matrix and user experience measure matrix are extracted, the method proceeds substantially as described above to confirm that the training data set is complete, assemble labelled training data pairs and infer a prediction function from the labelled training data pairs. Other numerical forms such as scalar, vector or multidimensional array may be used instead of matrices.

The method 300, implemented at user equipment and at the network, may be implemented in hardware, or as software modules running on one or more processors. The method may also be carried out according to the instructions of a computer program, and the present invention also provides a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

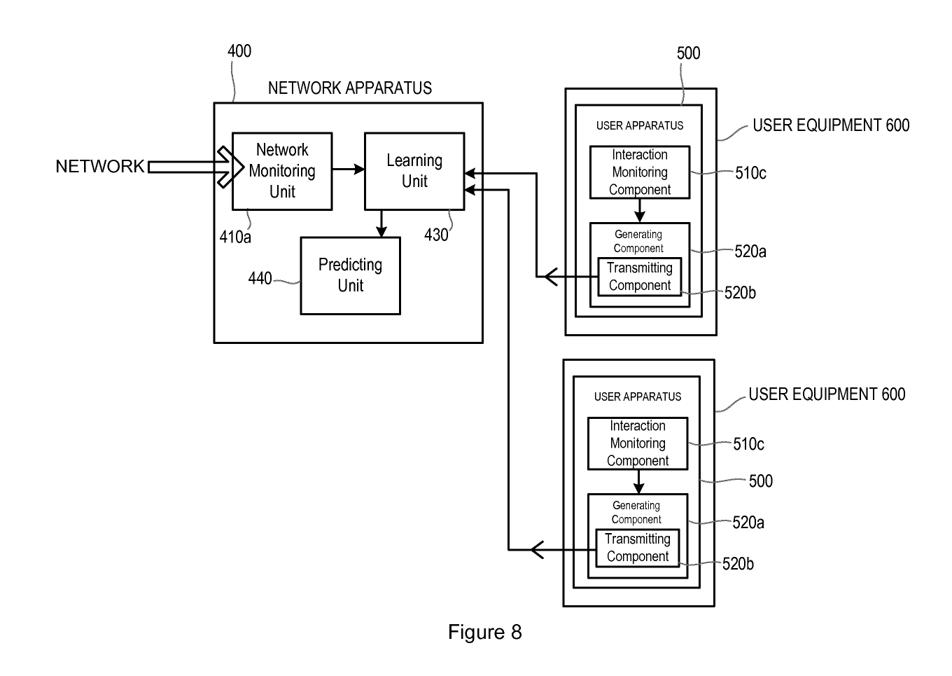

FIG. 8 illustrates functional units of a network apparatus 400 and two examples of user apparatus 500 which may execute the steps of the method 300, for example according to computer readable instructions received from a computer program. The apparatus 400 and 500 may for example comprise a processor or any other suitable apparatus.

With reference to FIG. 8, the network apparatus 400 comprises a network monitoring unit 410a, a learning unit 430 and a predicting unit 440. Each user apparatus 500 comprises an interaction monitoring component 510c and a generating component 520a. The generating component 520a further comprises a transmitting component 520b. The user apparatus 500 is integrated with or attached to a user equipment device 600. It will be understood that the units of the network apparatus and user apparatus are functional units, and may be realised in any appropriate combination of hardware and or software.

According to an example of the invention, the user apparatus 500 is configured to perform the steps illustrated in FIG. 6. The interaction monitoring component 510c is configured to receive and store sensor measurements. The sensor measurements may be collected by sensing equipment mounted on or in or in communication with a user equipment 600, on which the user apparatus 500 is mounted or formed. The generating component 520a is configured to retrieve the sensor measurements from the interaction monitoring component 510c and to generate a user experience measure from the sensor measurements. The transmitting component 520b is configured to transmit the generated user experience measure to the network apparatus 400.

According to the example, the network apparatus 400 is configured to perform the steps illustrated in FIG. 7. For each user contributing to a training data set, the network monitoring unit receives and stores network data for the user from the network. The network monitoring unit may also extract form the network data a network data feature matrix (or vector etc) for the user. Alternatively, the step of extracting a network data feature matrix may be performed in the leaning unit 430. The learning unit 430 receives network data or a network data feature matrix for the user from the network monitoring unit 410a and also receives a user experience measure for the user from the user apparatus 500. The learning unit 430 is configured to extract a user experience measure matrix (or vector etc) for the user from the user experience measure, in the event that the user experience measure is not transmitted to the learning unit in a form suitable for use as training data. The learning unit is configured to infer a prediction function linking network data to user experience measure from the network data and user experience measures received at the learning unit. The predicting unit 440 is configured to use the inferred prediction function to predict user experience measures for users within the network.

It should be noted that the above-mentioned examples illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of assessing user experience for users accessing a network via user equipment, comprising:
monitoring network data and user-user equipment interaction data for a plurality of users within the network;
generating a measure of user experience from the monitored user-user equipment interaction data for at least some of the plurality of users;
inferring a function relating network data to user experience measure from the monitored network data and the generated user experience measures; and
using the inferred function to predict user experience measures from network data for users within the network.

2. The method of claim 1, wherein monitoring user-user equipment interaction data comprises receiving and storing user-user equipment interaction data measured by sensors.

3. The method of claim 1, wherein generating a measure of user experience comprises applying an algorithm to the user-user equipment interaction data to arrive at a user experience measure.

4. The method of claim 1, wherein inferring a function comprises applying a machine learning technique to produce an inferred function.

5. The method of claim 1, wherein the machine learning technique is a supervised learning technique which employs the monitored network data and generated user experience measures as training data.

6. The method of claim 1, further comprising:
grouping users within the network according to at least one user attribute; and
selecting the plurality of users from a single group within the network.

7. A computer program product comprising a non-transitory computer readable medium storing code configured to implement the method of claim 1 when run on a computer.

8. A system configured to assess user experience for users accessing a network via user equipment, the system comprising one of more processors for:
monitoring network data and user-user equipment interaction data for a plurality of users within the network;
generating a measure of user experience from the monitored user-user equipment interaction data for at least some of the plurality of users;
inferring a function relating network data to user experience measure from the monitored network data and the generated user experience measures; and
using the inferred function to predict user experience measures from network data for users within the network.

9. The system of claim 8, wherein the system is at least partially realised within a network apparatus.

10. The system of claim 8, wherein the system further comprises a receiver for receiving network data and the processors are further configured to record user-user equipment interaction data.

11. The system of claim 10, wherein the system comprises a plurality of interaction monitoring components, and wherein each interaction monitoring component is realised within a specific user equipment.

12. The system of claim 11, wherein the system comprises a plurality of processors, and wherein each processor is realised within a specific user equipment.

13. The system of claim 8, wherein system is configured to apply a machine learning technique to produce an inferred function.

14. A network apparatus comprising:
a network monitoring unit configured to monitor network data;
a learning unit; and
a predicting unit configured to predict user experience measures for users within the network;
wherein the learning unit is configured to:
receive network data form the network monitoring unit,
receive a user experience measure from a user apparatus, and
infer a function relating network data to user experience measure;
and wherein the predicting unit is configured to use the inferred function to predict user experience measures.

15. A user apparatus comprising:
a transmitter; and
one or more processors for:
monitoring interaction data between a user and a user equipment associated with the user apparatus; and
generating a measure of user experience from the monitored user-user equipment interaction data; and
employing the transmitter to transmit the user experience measure to a network apparatus.
